(19) United States
(12) Patent Application Publication
(10) Pub. No.: US 2014/0323320 A1
(43) Pub. Date: Oct. 30, 2014

(54) METHOD OF DETECTING FUSED TRANSCRIPTS AND SYSTEM THEREOF

(71) Applicants: Wenlong Jia, Shenzhen (CN); Kunlong Qiu, Shenzhen (CN); Guangwu Guo, Shenzhen (CN); Minghui He, Shenzhen (CN); Jun Wang, Shenzhen (CN); Jian Wang, Shenzhen (CN); Huanming Yang, Shenzhen (CN)

(72) Inventors: Wenlong Jia, Shenzhen (CN); Kunlong Qiu, Shenzhen (CN); Guangwu Guo, Shenzhen (CN); Minghui He, Shenzhen (CN); Jun Wang, Shenzhen (CN); Jian Wang, Shenzhen (CN); Huanming Yang, Shenzhen (CN)

(73) Assignee: BGI TECH SOLUTIONS CO., LTD., Shenzhen (CN)

(21) Appl. No.: 14/369,566

(22) PCT Filed: Dec. 31, 2011
(86) PCT No.: PCT/CN2011/085216

§ 371 Date: Jul. 16, 2014

(51) Int. Cl. G06F 19/22

(52) U.S. Cl. CPC G06F 19/22
USPC 506/2; 702/19

(57) ABSTRACT

Provided is a method of detecting method of detecting fusion transcripts in a sample to be analyzed. The method may comprises: subjecting the sample to be analyzed containing a RNA transcriptome to paired-end sequencing, to obtain paired-end RNA-Seq data of the sample to be analyzed; aligning the paired-end RNA-Seq data to a human reference genome sequence, to obtain first paired-end mapped reads, first single-end mapped reads, and first unmapped reads; evaluating an insertsize between two ends of the paired-end mapped reads by means of the first paired-end mapped reads, to obtain a proportion of paired-end mapped reads with overlapped 3′-ends; aligning the first unmapped reads to annotated transcripts, to obtain second single-end mapped reads and second unmapped reads; aligning the second unmapped reads to the annotated transcripts, to filter out unmapped reads caused by indel and obtain third unmapped reads; merging all single-end mapped reads, to obtain a set of single-end mapped reads; obtaining a gene pair linked by a cross-read as a primary set of candidate gene pairs based on the set of single-end mapped reads and combining with a relationship of the mapped paired-end reads; subjecting the primary set of candidate gene pairs to a filtration, to obtain a candidate set of fused gene pairs; bisecting the third unmapped read, to obtain a half-unmapped read; aligning the half-unmapped read to a gene-junction sequence in the candidate set of fused gene pairs, to obtain a potent region of a fused junction site in the gene in which the half-unmap read locates; outputting original reads of mapped half-unmapped reads, to obtain useful unmapped reads; subjecting the candidate set of fused gene pairs to a fusion simulation; aligning the useful unmapped reads to a junction library, to obtain a fused gene supported by the useful unmapped reads; calculating and gathering the fused sequence supported by the useful unmapped reads, to obtain information of the fused gene. And a system for detecting fusion transcripts is also provided.

### TECHNICAL FIELD

Embodiments of the present disclosure generally relate to fields of biotechnology and bioinformatics, more particularly, to a method of detecting fused transcripts and a system thereof.

### BACKGROUND

Changes in DNA sequence may classified into four types: single nucleotide polymorphism (SNP), insertion and deletion (Indel), structure variation (SV), and copy number variation (CNV).

A DNA mutation affects a transcription of a gene sequence, which further affects a coded protein thereof, finally embodied in epigenetic abnormalities such as cells, tissues and human body. A chromosomal aberration, particularly a structure variation (SV), leads to a production of a fused gene.

RNA sequencing (RNA-seq) is a technique directing at a transcript based on a Next-Generation sequencing platform. Comparing with traditional microarray technology, the RNA sequencing does not need to design a probe, may provide a higher detection throughput and a wilder detection range, and generate a larger data volume. Using RNA-seq data for fused gene detection may obtain a more comprehensive result. Recently, several computational methods, including FusionSeq, TopHat-Fusion, deFuse, FusionHunter, FusionMap. Such software use different detection strategies, which have different difficulties and different requirements for technical levels of users and hardware system run thereof. For instance, FusionSeq consumes a relative larger amount of computational resource (CPU time, memory usage) and hard disk used for storage, which is not suitable for analyzing hundreds of samples in parallel; TopHat-Fusion requires a larger running memory (for example 9G memory by a single thread processing, and times of memories by a multi-thread processing), and a default directory which does allow a user to set a new directory in accordance with a self-intension; deFuse requires a relative larger memory (20G) having a complex database, accordingly it is difficult to build a database by a user, more depending on a database downloaded from website; FusionHunter requires a relative larger memory (10G), which is not able to analyze data obtained from multi-sequencing one single sample; FusionMap requires running under windows environment, if FusionMap runs under Linux system depending on a virtual machine which is unstable during debugging and running, it requires a relative larger memory. Software consuming a relative larger amount of computational resource and hard disk used for storage may increase research cost, having difficulties in constructing database and a long running time may delay research progress.

In summary, there is still no effective method of detecting fused transcripts and software thereof in prior art. Thus, rapid, effective and economic technology and system for detecting fused transcripts are urgent needed in prior art.

### SUMMARY

One purpose of the present disclosure is to provide a method of detecting fused transcripts and a system thereof.

The other purpose of the present disclosure is to provide use of the above provided method and system.

In one aspect of the present disclosure, there is provided a method of detecting fused transcripts in a sample to be analyzed. According to embodiments of the present disclosure, the method of the present disclosure may comprise following steps:

subjecting the sample to be analyzed containing a RNA transcriptome to paired-end sequencing, to obtain paired-end RNA-Seq data of the sample to be analyzed;

aligning the paired-end RNA-Seq data to a human reference genome sequence, to obtain first paired-end mapped reads, first single-end mapped reads, and first unmapped reads;

evaluating an insertsize between two ends of the paired-end reads using the first paired-end mapped reads, to obtain a proportion of paired-end mapped reads with overlapped 3′-ends;

aligning the first unmapped read to annotated transcripts, to obtain second single-end mapped reads and second unmapped reads;

aligning the second unmapped read to the annotated transcripts, to filter out unmapped reads caused by indel and obtain third unmapped reads;

merging all single-end mapped reads, to obtain a set of single-end mapped reads;

obtaining a gene pair linked by a cross-read as a primary set of candidate gene pairs based on the set of single-end mapped reads and combining with a relationship of the paired-end reads;

subjecting the primary set of candidate gene pairs to a filtration, to obtain a candidate set of fused gene pairs;

bisecting the third unmapped read, to obtain a half-unmapped read;

aligning the half-unmapped read to a gene-junction sequence in the candidate set of fused gene pairs, to obtain a potent region of a fused junction site in the gene in which the half-unmap read locates;

outputting original reads of mapped half-unmapped reads, to obtain useful unmapped reads;

subjecting the candidate set of fused gene pairs to a fusion simulation; aligning the useful unmapped reads to a junction library, to obtain a fused gene supported by the useful unmapped reads;

calculating and gathering the fused sequence supported by the useful unmapped reads, to obtain information of the fused gene.

According to a preferred embodiment of the present disclosure, the information of the fused gene is at least one selected from a group consisting of:

fused gene site, gene ID, plus or minus strand of gene, chromosome in which gene locates, a position of fused site in gene, or a combination thereof.

According to a preferred embodiment of the present disclosure, the first paired-end mapped reads indicates reads having a relationship of paired-end mapped reads, and the intersize between two ends of the paired-end reads satisfies Formula I:

0<insert size<10K Formula I.

According to a preferred embodiment of the present disclosure, the first single-end mapped reads is at least one selected from a group consisting of:

a) single read being able to be mapped to the human reference genome sequence; and/or

b) reads having the relationship of paired-end reads and being able to be mapped to the human reference genome sequence, and the intersize between two ends of the paired-end reads doses not satisfy Formula I.

According to a preferred embodiment of the present disclosure, the first unmapped reads are: reads being unable to be mapped to the human reference genome sequence.

According to a preferred embodiment of the present disclosure, if the proportion of paired-end mapped reads with overlapped 3′-ends exceeds a threshold, the method further comprises:

subjecting the second unmapped reads to a trimming operation, to obtain a trimmed third unmapped reads by which the paired-end reads with overlapped 3′-ends is converted into paired-end reads with a gap between two 3′-ends; and

aligning the trimmed third unmapped reads to the annotated transcript, to obtain third single-end mapped reads.

According to a preferred embodiment of the present disclosure, the threshold preferably is 5% to 50%, more preferably is 10% to 30%, most preferably is 20%.

According to a preferred embodiment of the present disclosure, the first filtration is at least one selected from a group consisting of:

(A) filtering out juxtaposition genes having a homogenous exon region;

(B) filtering towards a cross-read orientation, to retain fused paired reads having a fusing orientation supported by most cross-read; and

(C) filtering out alternative splicing.

According to a preferred embodiment of the present disclosure, the filtration further comprises: filtering out gene pairs from the same gene families.

According to a preferred embodiment of the present disclosure, the step of calculating comprises:

subjecting reads with determined fusion status to the calculation, based on the useful unmapped reads mapped to a simulated sequence by partial exhaustion algorithm and cross-read in the candidate gene pair.

According to a preferred embodiment of the present disclosure, the step of gathering comprises:

filtering a candidate fusion with criterions, wherein the criterions are:

simplified fusion within one same gene pair, preferably, a gene fusion presenting in a boundary of exons is retained; and

filtering out a fused site between homogenous genes, to remove a fused sequence containing a fused site located in a homogenous region between genes.

According to a preferred embodiment of the present disclosure, the method further comprises a step of:

drawing an svg figure showing fusion status based on the calculated and gathered result; and/or

drawing a graph showing expression level of gene pairs; and

creating the fused gene.

According to a preferred embodiment of the present disclosure, the method is used in:

verifying gene fusion in a RNA level; or

determining whether or not the fusion results from DNA structure variation; or

providing absolute expression levels of two genes involved in the fusion; or

a combination thereof.

In another aspect of the present disclosure, there is provided a system for detecting fused transcripts in a sample to be tested. According to embodiments of the present disclosure, the system may comprise:

an aligning unit, configured to align sequencing data to a reference sequence;

a filtering unit, configured to filter or exclude sequencing data with a low confidence and being wrong;

a fusion simulating unit, configured to subject a candidate set of fused gene pairs to a fusion simulation, to obtain a fused gene;

a reads cutting unit, configured to bisect third unmapped reads, to obtain half-unmap/1 and half-unmap/2.

According to a preferred embodiment of the present disclosure, the system further comprises at least one unit selected from a group consisting of:

a receiving unit, configured to receive paired-end RNA-Seq data of the sample to be analyzed;

a fused gene predicting unit, configured to predict the fused gene based on the half-unmap/1 and half-unmap/2;

a figure drawing unit.

According to a preferred embodiment of the present disclosure, the aligning unit comprises at least one module selected from a group consisting of:

a first aligning module, configured to align paired-end RNA-Seq data to a human reference genome sequence;

a second aligning module, configured to align first unmapped reads to annotated transcripts;

a third aligning module, configured to align second unmapped reads to the annotated transcripts;

a fourth aligning module, configured to align half-unmap reads deriving from third unmapped reads to a gene-junction sequence in a candidate set of fused gene pairs.

According to a preferred embodiment of the present disclosure, the filtering unit comprises at least one module selected from a group consisting of:

a first filtering module, configured to filter a gene pair linked by a cross-read as a primary set of candidate gene pairs; and/or

a second filtering module, configured to filter a fused gene supported by useful unmapped reads.

According to a preferred embodiment of the present disclosure, the first filtering module is used in

(A) filtering out juxtaposition genes having a homogenous exon region;

(B) filtering towards a cross-read orientation, to retain fused paired reads having a fusing orientation supported by most cross-read; and

(C) filtering out alternative splicing.

According to a preferred embodiment of the present disclosure, the first filtering module for the primary set of candidate gene pairs is further used in filtering out gene pairs from the same gene families.

According to a preferred embodiment of the present disclosure, the second filtering module for filtering the fused gene supported by the useful unmapped reads satisfies following criterions:

simplified fusion within one same gene pair, preferably, a gene fusion presenting in a boundary of exons is retained; and

filtering out a fused site between homogenous genes, to remove a fused sequence containing a fused site located in a homogenous region between genes.

According to a preferred embodiment of the present disclosure, the reads cutting unit is used in:

bisecting the third unmapped reads, to obtain half-unmap/1 and half-unmap/2.

According to a preferred embodiment of the present disclosure, the reads cutting unit bisects the third unmapped reads into two isometric segments, to obtain the half-unmap/1 and half-unmap/2 having same length.

According to a preferred embodiment of the present disclosure, the figure drawing unit comprise:

a first drawing module, configured to draw alignments of supporting reads;

a second drawing module, configured to draw svg figures showing absolute expression level of two genes involved in the fusion.

It should note that, in the range of the present disclosure, every of the above mentioned technical features may be mutually combined with every technical feature specifically described below (such as Examples), so as to construct new or optimized technical solutions, which are omitted herein due to space limitation.

### BRIEF DESCRIPTION OF THE DRAWINGS

Following figures are for illustrating specific embodiments of the present disclosure, which are not constructed to limit the range of the present disclosure defined by claims.

FIG. 1 is a schematic diagram showing a distribution of exons and a corresponding relationship of several transcripts and a junction sequence thereof.

FIG. 2 is a schematic diagram showing a general fused gene model (5′->A->B->3′).

FIG. 3 is a schematic diagram showing a general paired-end sequencing model.

FIG. 4 is a schematic diagram showing two types of paired-end sequencing involved in the present disclosure.

FIG. 5 is a schematic diagram showing a general model of cross-read and span-read.

FIG. 6 is a flow chart showing a method of detecting fused transcripts according to an embodiment of the present disclosure.

FIG. 7 is a schematic diagram showing a step of enabling a trimming operation accessible in paired-end reads with overlapped 3′-ends.

FIG. 8 is a schematic diagram showing a general partial exhaustion algorithm model.

### DETAILED DESCRIPTION

By extensive and in-depth study, inventors in the present disclosure firstly establish a quick, simple and accurate method of detecting fused transcripts. In details, the method comprises following steps:

subjecting the sample to be analyzed containing a RNA transcriptome to paired-end sequencing, to obtain paired-end RNA-Seq data of the sample to be analyzed;

aligning the paired-end RNA-Seq data to a human reference genome sequence, to obtain first paired-end mapped reads, first single-end mapped reads, and first unmapped reads;

evaluating an insertsize between two ends of the paired-end reads by means of the first paired-end mapped reads, to obtain a proportion of paired-end mapped reads with overlapped 3′-ends;

aligning the first unmapped read to annotated transcripts, to obtain second single-end mapped reads and second unmapped reads;

aligning the second unmapped read to the annotated transcripts, to filter out unmapped reads caused by indel and obtain third unmapped reads;

merging all single-end mapped reads, to obtain a set of single-end mapped reads;

obtaining a gene pair linked by a cross-read as a primary set of candidate gene pairs based on the set of single-end mapped reads and combining with a relationship of the paired-end reads;

subjecting the primary set of candidate gene pairs to a filtration, to obtain a candidate set of fused gene pairs;

bisecting the third unmapped read, to obtain a half-unmapped read;

aligning the half-unmapped read to a gene-junction sequence in the candidate set of fused gene pairs, to obtain a potent region of a fused junction site in the gene in which the half-unmap read locates;

outputting original reads of mapped half-unmapped reads, to obtain useful unmapped reads;

subjecting the candidate set of fused gene pairs to a fusion simulation;

aligning the useful unmapped reads to a junction library, to obtain a fused gene supported by the useful unmapped reads;

calculating and gathering the fused sequence supported by the useful unmapped reads, to obtain information of the fused gene.

The present disclosure also provides a system for detecting fused transcripts in a sample to be analyzed, the system comprises: a receiving unit; an aligning unit; a filtering unit; a fusion simulating unit; a reads cutting unit. In a preferred embodiment of the present disclosure, the system further comprises a fused gene predicting unit and a figure drawing unit.

The present disclosure is completed based on the above.

Term

Gene and Exon

The term “gene” used herein refers to a basic unit of biological inheritance, presenting in a gene region of a genome. In eukaryote, a gene includes an intron and an exon. The gene usually includes several exons. In many instances, the gene has several transcripts: each transcript corresponds to a different combination by multiple exons of such gene, even an exon having a cut off of several bases towards the exon at a boundary with an adjacent intron, or an exon having an extension of several towards an adjacent intron, which are alternative splicing. For these reasons, one gene may have several transcripts.

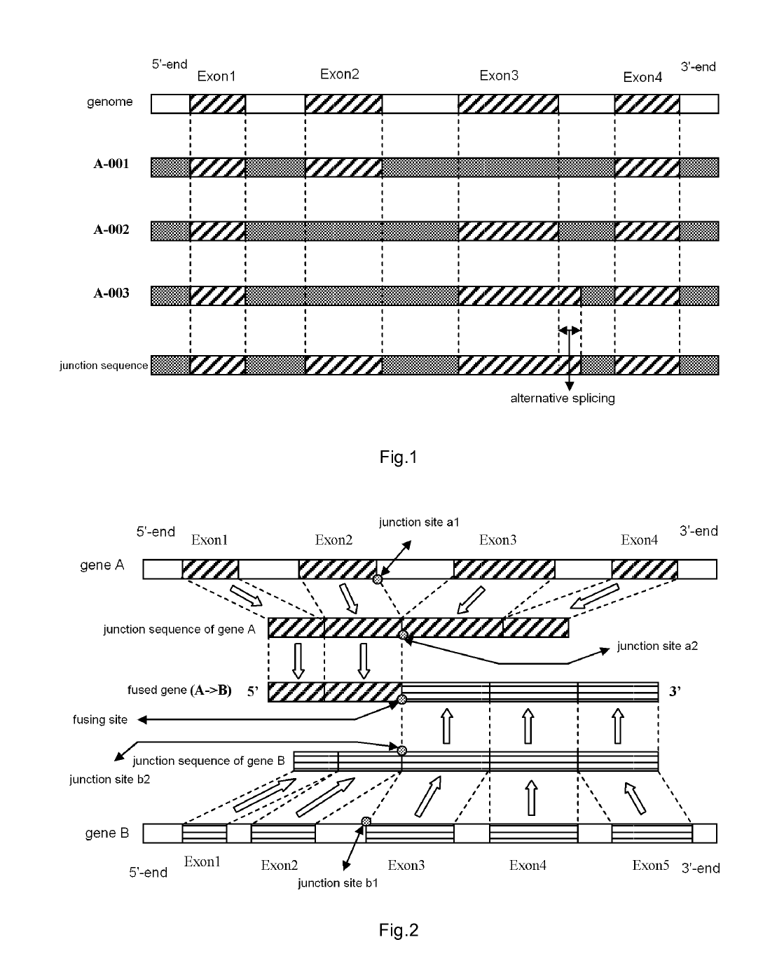

FIG. 1 shows a distribution of several exons and a corresponding relationship of several transcripts and a junction sequence thereof by taking gene A as an example. There are five lines of sequences in FIG. 1, which are a genome, A-001, A-002, A-003 and a junction sequence from top to bottom, in which each sequence having an orientation from 5′-end (left) to 3′-end (right). Sequence of the first line is a genome sequence, representing a distribution of the gene A in a DNA sequence. The gene A totally involves four exons (Exon1 to Exon4), representing by a shadow of slashes. Regions between two adjacent exons are intron regions. Sequences of A-001, A-002 and A-003 respectively are three transcripts of the gene A, the involving exons are shown in FIG. 1: A-001 includes Exon1, Exon2 and Exon4; A-002 includes Exon1, Exon3 and Exon4; A-003 includes Exon1, Exon3 (an alternative splicing presents at 3′-end of the Exon3) and Exon4. The bottom sequence is a junction sequence obtained by all transcripts of the gene A, including all involved exon sites in the transcripts of the gene A (as shown in FIG. 1, particularly the alternative splicing uniquely presenting in A-003, also presents in the junction sequence). Such junction sequence is the gene sequence being used in the present disclosure, a fused junction site of the gene A is looked for in the junction sequence. For the transcripts of A-001, A-002, A-003 and the junction sequence, an actual sequence for use is obtained by connecting respective exons in an orientation from 5′-end (left) to 3′-end (right) after discarding introns (a shadow of dots) between two adjacent exons.

Fused Gene

The term “fused gene” used herein is a combination of two or more different genes or segments or segments deriving from respective genes.

The fused gene is classified into two types based on formation: RNA level or DNA level. A regulated or random fusion occurs among RNA, particularly among free RNA sequence. A variation in DNA sequence leads to a connection of gene DNA regions, which further results in a fused gene obtained by transcription of such connection region. the fused gene obtained thereof may be classified into two types: 1) a fused gene arising from nearer positions in one chromosome, mainly results from transcription skipping a terminator, alternative splicing, homogenous/overlapping regions, inversion and etc; 2) a fused gene arising from ulterior positions in one chromosome or from different chromosomes, mainly results from structure variation (translocation, insertion ant etc). Analyzing fused genes based on RNA-Seq data may determine fusion status at an expression level, which needs further data support and experiments detection on whether the fusion is at RNA level or at DNA level.

FIG. 2 shows a general fused gene model, in which gene A and gene B fuses in an orientation from 5′-end to 3′-end, the gene A is upstream gene, the gene B is downstream gene, orientations thereof are both from 5′-end to 3′-end. There are five lines of sequences in FIG. 2, from top to bottom which are a sequence of gene A showing a distribution of exons in genome, a junction sequence of gene A, a sequence of an A-B fused gene, a junction sequence of gene B, a sequence of gene B showing a distribution of exons in genome. The exons of gene A is represented by shadows of slashes, the exons of gene B is represented by shadows of horizontal lines. The gene A has four exons and the gene B has five exons, the A-B fused gene is obtained by connecting an upstream fused segment which derives from Exon1 and Exon2 in the gene A with a downstream fused segment which derives from Exon3, Exon4 and Exon5 in the gene B in an orientation from 5′-end to 3′-end. An key junction site and a fused site are shown as a solid dot respectively in each of the five sequences, which are: junction site a1, junction site a2, fused site, junction site b2 and junction site b1. By detecting a position of the fused site in the fused gene, the present disclosure may find the junction site (junction site a2, junction site b2) in the upstream/downstream fused segment (junction sequence), and may convert the junction site in the upstream/downstream fused segment back to the junction site in whole genome (junction site a1, junction site b1). Accordingly, a final result of junction sites a1 and b1 in whole genome may be obtained, which are annotated in a chromosome and a gene belonged.

Paired-End Sequencing

Gene segment (including DNA, cDNA) to sequencing, in which sequencing objective is a length of segment having physically continuous bases sequence, such segment is named as an insert segment having a length named insertsize.

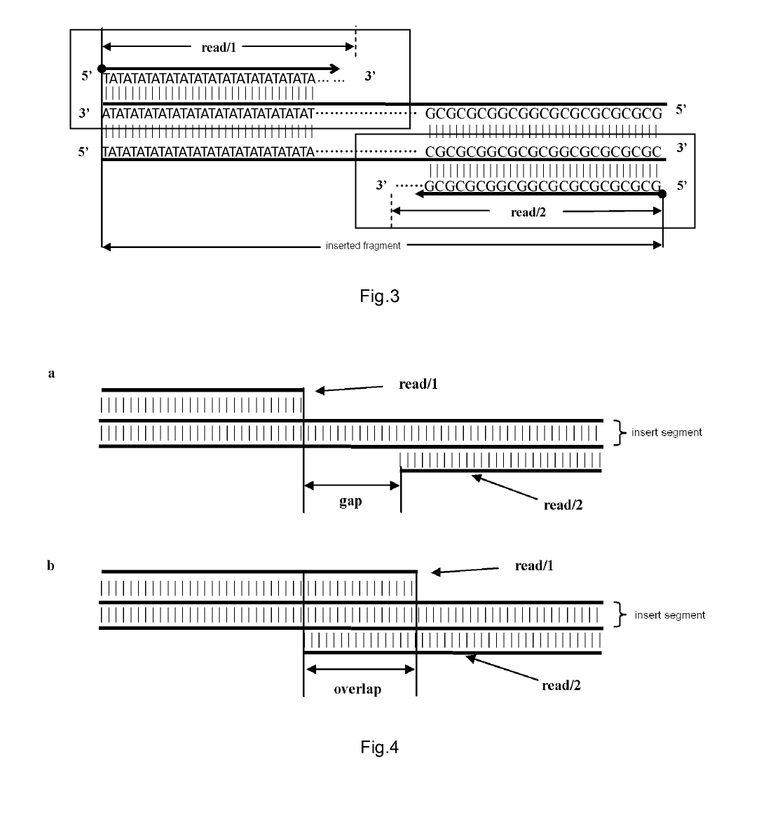

The term “paired-end sequencing” refers to a method of sequencing two strands of the insert segment from respective end towards interior, an obtained sequence by sequencing is named as a read of which a length is known as read-length. Reads respectively obtained from the two strands derives from the same insert segment. A distance between two most outer ends of each group is named insertsize, by which a pairwise relationship of two reads respectively obtain from sequencing two strands. Such two reads are regarded as paired-end reads. The pairwise relationship of paired-end reads may be used in analysis, for example, most commonly used in alignment. FIG. 3 shows a general paired-end sequencing model, FIG. 4 shows two types of paired-end sequencing involved in the present disclosure.

There are four lines of sequences in FIG. 3, in which sequence of the first line is read/1 of paired-end reads; sequences of the second and third lines is a double-strand structure being sequenced, corresponding bases respectively in the double strands are mutually complementary, interior bases of the insert segment are omitted as continuous pots ( . . . ); sequence of the fourth line is read/2 of paired-end reads. For conveniently observing, read/1a and read/2 are marked with a rectangle respectively; read/1 a and read/2 are both obtained by sequencing the insert segment from respective end of two strands, an initial synthesizing site is marked as a dot respectively end of two stands shown as two bold lines, the sequencing extends towards the interior of the insert segment, an extending orientation is represented at the other end of the bold line using an arrow. All sequences of every lines shown in FIG. 3 are annotated the extending orientation, the extending orientation of read/1 is from 5′-end to 3′-end, the extending orientation of a template strand is from 3′-end to 5′-end, both of which follow the principle of complementary and pairwise bases, read/2 is in a similar way. Read synthesis is similar with transcription, from the extending orientation of sequencing, the extending orientation of the template strand (the insert segment) is from 3′-end to 5′-end, the extending orientation of a newly-synthesized read is from 5′-end to 3′-end.

FIG. 4 shows two types of paired-end sequencing involved in the present disclosure, which are paired-end reads with a pap between 3′-ends (FIG. 4a) and paired-end reads with overlapped 3′-ends (FIG. 4b), respectively. In FIG. 4, it shows an insert segment to be sequenced, read/1 and read/2, a relationship of complementary and pairwise bases is represented by vertical lines. In FIG. 4a, there is a gap in the insert segment which has not been sequenced between two paired-end reads, in FIG. 4b, there is an overlap between two paired-end reads. The case in FIG. 4a is regarded as paired-end reads with a pap between 3′-ends, the case in FIG. 4b is regarded as paired-end reads with overlapped 3′-ends.

Cross-Read and Span-Read

The present disclosure involves two types of reads for determine a final fusion status, which are defined as cross-read and span-read.

Assuming that gene A fused with gene B, the formation thereof should be a length of sequence of the gene A connecting with a length of sequence of the gene B at a fused junction site; two reads respectively deriving from gene A segment and gene B segment obtains by paired-end sequencing the fused gene, accordingly such paired-end reads are named as cross-read, which derives from two different genes (aligned to different genes). In the case of a fusion between two sequences, there is one single read striding the fused junction site, i.e., one part of the fused sequence derives from the gene A, the other one part of the fused sequence derives from the gene B, a contact site of the two parts is just the fused junction site, such read is named as span-read. Thus, cross-read refers to two reads having a pairwise relationship; span-read refers to the single read.

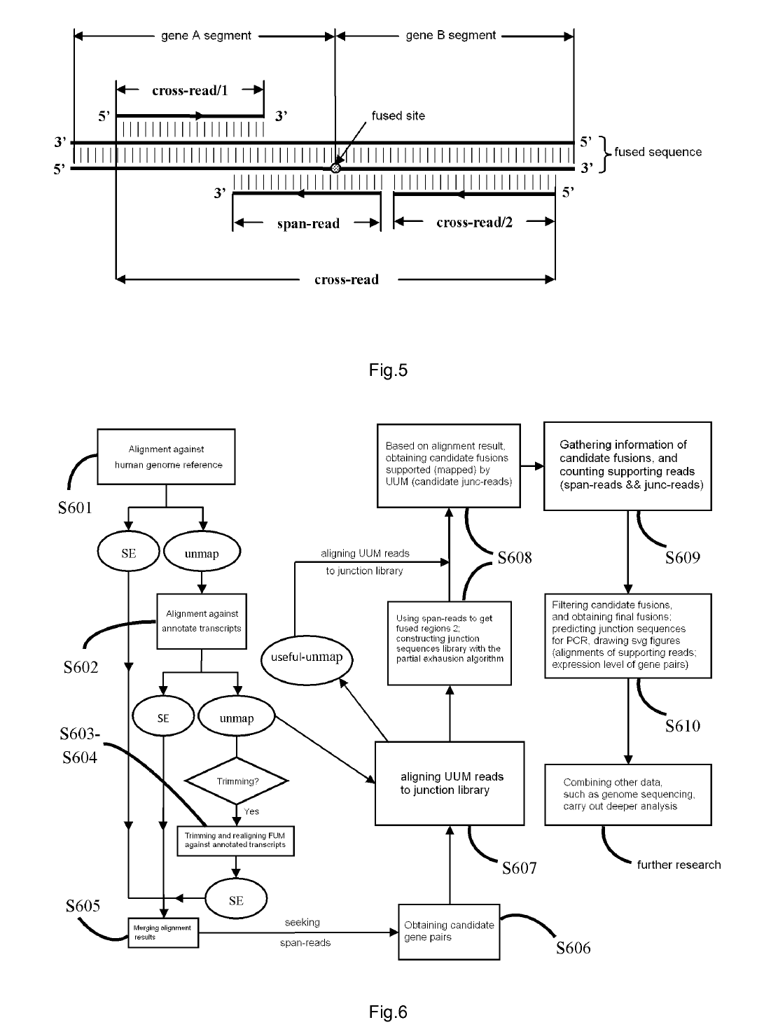

FIG. 5 shows a general model of cross-read and span-read, which a fused site is marked as a solid dot in a fused sequence, a strand in which the solid dot locates is a fused RNA sequence having an orientation from 5′-end to 3′-end, a complementary strand thereof is a complementary and pairwise strand during paired-end sequencing. Gene A segment and gene B segment shown in FIG. 5 do not represent an entire fused sequence of these two genes, of which two ends thereof may extend to an end of gene or transcript respectively from two sides. One pair of paired-end reads are shown, i.e., cross-read: cross-read/1 and cross-read/2 with characteristics of respectively matching to the gene A and the gene B, and both cross-read/1 and cross-read/2 do not extend over the fused site. One of span-read is also shown in FIG. 5 with characteristics that one part of sequence derives from the gene A and the other one of sequence derives from the gene B, accordingly the span-read strides the fused site. All extension orientations during synthesis are annotated by an arrow in read shown as a bold line.

Trimming Operation in Paired-End Reads with Overlapped 3′-Ends

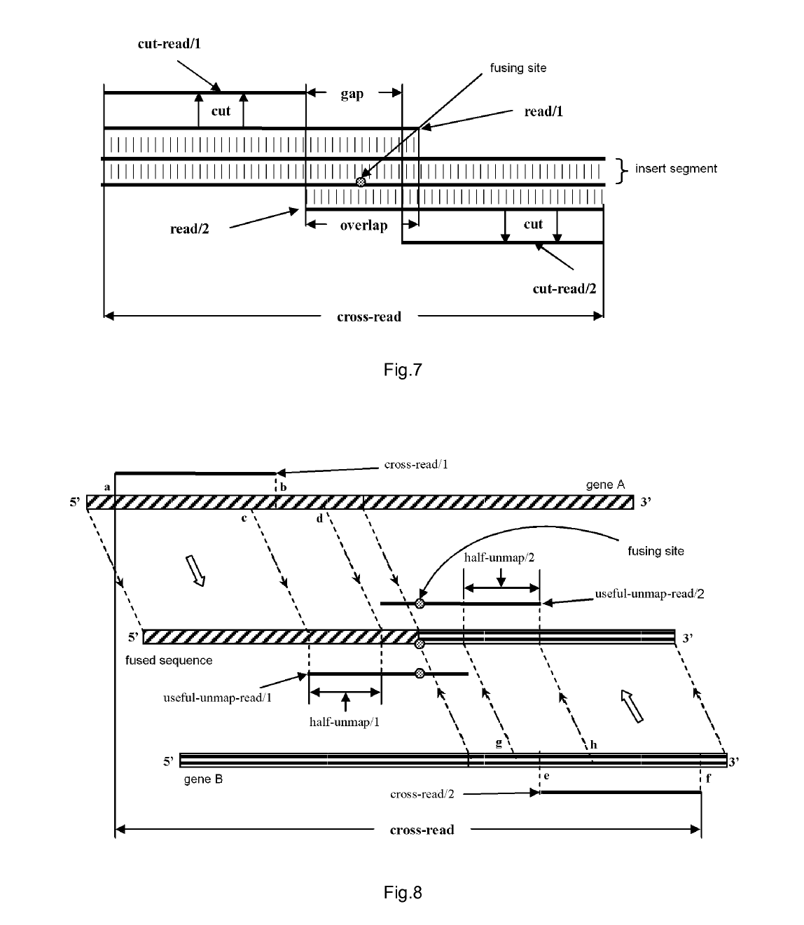

The method of the present disclosure further comprises a step of enabling a trimming operation accessible in paired-end reads with overlapped 3′-ends (FIG. 7). FIG. 7 shows that during sequencing an insert fragment, original paired-end reads are read/1 and read/2, which are paired-end reads with overlapped 3′-ends, meaning that there is an overlap region between two 3′-end of read/1 and read/2.

A key step in the method of the present disclosure is to find a cross-read supporting a fused gene pair, satisfying a condition that paired-end reads respectively aligned to two fusion-involved genes. However, the paired-end reads with overlapped 3′-ends cannot provide such cross-read, for example, an insert segment is a fused sequence marked with a fused site using a solid dot, it can be seen that read/1 and read/2 both stride the fused site, i.e., both read/1 and read/2 contains sequences deriving from two fusion-involved genes, accordingly such paired-end reads are not able to be mapped to any one of genes during aligning.

The step of enabling a trimming operation accessible in read/1 and read/2 in the method of the present disclosure may trim the fused site out from read/1 and read/2. Then a gap is formed between 3′-ends of trimmed read/1 and trimmed read/2, in which the trimmed read/1 and trimmed read/2 belong to a cross-read which may be used in supporting a fused case corresponded by such fused segment.

General Partial Exhaustion Algorithm Model

The present disclosure further provides a general partial exhaustion algorithm model (FIG. 8). There are cross-read and two useful-unmap-read in FIG. 8. In paired-end reads of cross-read: cross-read/1 is able to be aligned to a region in gene A from site a to site b, cross-read/2 is able to be aligned to a region in gene B from site e to site f. Every useful-unmap-read is bisected into two isometric segments, each called a half-unmapped read, in which one close to 5′-end is named as half-unmap/1, and the other one is named as half-unmap/2. After the half-unmapped read is aligned to a gene-fused sequence, a mapped position and a mapped orientation are obtained. In one preferred embodiment of the present disclosure, if half-unmap/1 is able to be mapped to the gene A in an orientation of plus strand with a mapped rang of [a, b], then half-unmap/1 has a length of b−a+1. As half-unmap/1 supports that a fused junction site presents in the gene A within a certain range, which corresponds to a range of half-unmap/2, then a range of [b+1,b+(b−a+1)] in which the fused junction site presents is obtained by extending a distance of b−a+1 from the half-unmap/1 towards 3′-end of the gene A. While if half-unmap/1 is able to be mapped to the gene A in an orientation of minus strand, then an extension needs towards an orientation of 5′-end in gene A. Various cases of extending orientations are shown in Table 1 (all assuming that half-unmap/1 is able to be mapped to gene A).

TABLE 1

| | half-unmap | |
|---|---|---|
| mapped orientation | half-unmap/1 | half-unmap/2 |
| mapped in an orientation | extending towards an | extending towards an |
| of plus strand | orientation of 3′-end | orientation of 5′-end |
| | in gene A | in gene A |
| mapped in an orientation | extending towards an | extending towards an |
| of minus strand | orientation of 5′-end | orientation of 3′-end |
| | in gene A | in gene A |

As shown in FIG. 8, the half-unmap/1 of the useful-unmap-read/1 is aligned to a region in gene A from site c to site d, the half-unmap/2 of the useful-unmap-read/2 is aligned to a region in gene B from site g to site h. A fused site in a fused sequence is shown as a solid dot.

Assuming that the cross-read having an intersize of S has been determined in previous steps, then simulating exhaustion sequences are obtained according to following ideas:

<1> a length of cross-read/1 should be b−a+1, similarly cross-read/2 has a length of f−e+1;

<2> an initial point of cross-read/1 involved in a region of gene A should be a, a termination point is a+S−1, i.e., [a, a+S−1].

<3> as cross-read itself is normally mapped to a gene, a range of a potent fused junction site in gene A should be a region of [a, a+S−1] discarding the cross-read covered, i.e., [b+1, (a+S−1)−(f−e+1)]; similarly, a range of a potent fused junction site in gene B is [(f−S+1)+(b−a+1), e−1], both of which are called paired-region;

<4> a mapped position of half-unmap read means having a fused junction site nearby, the potent region containing a fused junction site may be further determined based on the mapped site of half-unmap read. A region containing a fused junction site in gene A supported by half-unmap/1 is [d+1, d+(d−c+1)]; a region containing a fused junction site in gene B supported by half-unmap/2 is [(g−1)−(h−g+1), g−1], such region is called a fuse-region;

<5> all useful-unmap-read shown in FIG. 8 result from a fused gene, but useful-unmap-read not resulting from a fused gene cannot be avoided in actual data (actually being common), which may result from larger indel or alternative splicing. One of half-unmap reads obtained by bisecting such useful-unmap-read may be not subjected to these factors and be able to be mapped to gene, thus a mapped position provided such half-unmap read is completely irrelevant with the fused junction site. If a region supported by such half-unmap read is selected for an exhaustion connection, an accurate fusion result may never be obtained. Thus, a region supported by half-unmap read cannot be fully relied on;

<6> a specific fuse-region is obtained according to following algorithm:

a fuse-region of gene A and a fuse-region of gene B are subjected to an each site exhaustion connection;

a pair-region of gene A and a fuse-region of gene B are subjected to an each site exhaustion connection;

a fuse-region of gene A and a pair-region of gene B are subjected to an each site exhaustion connection.

Simulating a fused sequence in accordance with the above three cases may solve a problem that half-unmap reads are not completely correct, of which idea is an exclusive method, i.e., pair-regions (excluded a site of interior fuse-region) respectively deriving from two genes will never fuse, accordingly sites respectively located in such two regions will never be mutually exhaustion connected, then the above three cases are remained.

Site Exhausting Connection

Site exhausting connection is used in the present disclosure to simulating every fusion cases between gene A (upstream) and gene B (downstream), of which a principle is: assuming that a region between site a and site b in gene A is [a, b], a region between site c and site d in gene A is [c, d], these two regions are subjected to site exhausting connection. The exhaustion means all sites respectively in these two region are mutually connected once. A connecting point is represented as “|” below.

1. For site a in gene A, following cases exists:

a|c, a|(c+1), a|(c+2), . . . , a|(d−1), a|d, which are totally d−c+1 types.

2. similarly, for site a+1 in gene A, following cases exists:

(a+1)|c, (a+1)|(c+1), (a+1)|(c+2), . . . , (a+1)|(d−1), (a+1)|d, which are totally d−c+1 types.

3. . . . ; which are totally d−c+1 types.

4. . . . ; which are totally d−c+1 types.

5. . . . ; which are totally d−c+1 types.

. . .

b−a+1. . . . ; which are totally d−c+1 types.

For site b in gene A, there are still totally d−c+1 types.

Accordingly, after the exhausting connection, (b−a+1)*(d−c+1) types of connection generates between the region [a, b] in gene A and the region [c, d] in gene B.

In another preferred embodiment, a gene sequence selected by extending a range of a certain length (generally a read-length) at a connecting site respectively towards orientations of 5′-end (upstream) and 3′-end (downstream) in upstream and downstream gene, by then each case includes a connection between two selected sequences, being as a case of fused sequence obtained by simulating exhaustion algorithm. All connected simulating fused sequence may be taken as a reference sequence, to which useful-unmap-read is aligned. Which useful-unmap-read in the simulating fused sequence being supported may be found based on the obtained aligning result, so as to find the corresponding fusion status.

Detection Method

The present disclosure still provides a method of detecting fused transcripts. In one preferred embodiment of the present disclosure, the method comprises following steps:

subjecting the sample to be analyzed containing a RNA transcriptome to paired-end sequencing, to obtain paired-end RNA-Seq data of the sample to be analyzed;

aligning the paired-end RNA-Seq data to a human reference genome sequence, to obtain first paired-end mapped reads, first single-end mapped reads, and first unmapped reads;

evaluating an insertsize between two ends of the paired-end mapped reads by means of the first paired-end mapped reads, to obtain a proportion of paired-end mapped reads with overlapped 3′-ends;

aligning the first unmapped read to annotated transcripts, to obtain a second single-end mapped read and a second unmapped read;

aligning the second unmapped read to the annotated transcripts, to filter out unmapped reads caused by indel and obtain a third unmapped read;

merging all single-end mapped reads, to obtain a set of single-end mapped reads;

obtaining a gene pair linked by a cross-read as a primary set of candidate gene pairs based on the set of single-end mapped reads and combining with a relationship of the paired-end reads;

subjecting the primary set of candidate gene pairs to a filtration, to obtain a candidate set of fused gene pairs;

bisecting the third unmapped read, to obtain a half-unmapped read;

aligning the half-unmapped read to a gene-junction sequence in the candidate set of fused gene pairs, to obtain a potent region of a fused junction site in the gene in which the half-unmap read locates;

outputting original reads of mapped half-unmapped reads, to obtain useful unmapped reads;

subjecting the candidate set of fused gene pairs to a fusion simulation;

aligning the useful unmapped reads to a junction library, to obtain a fused sequence supported by the useful unmapped reads;

calculating and gathering the fused sequence supported by the useful unmapped reads, to obtain information of the fused gene candidate.

Major advantages of the present disclosure comprises:

1. consuming less memory and storage space of hard disk during processing;

2. simply used with an automatic process generated with a simpler and clearer directory;

3. a shorter period for data processing;

4. a simpler operation for constructing basic database;

5. a higher efficiency and performance of detecting a fusion variation;

6. being a rapid processing method to obtain a reliable result consuming low cost.

Reference will be made in detail to examples of the present disclosure. It would be appreciated by those skilled in the art that the following examples are explanatory, and cannot be construed to limit the scope of the present disclosure. If the specific technology or conditions are not specified in the examples, a step will be performed in accordance with the techniques or conditions described in the literature in the art (for example, referring to J. Sambrook, et al., Molecular Cloning: A Laboratory Manual (New York: Cold Spring Harbor Laboratory Press, 1989) or in accordance with the product instructions.

### Example 1

The present disclosure illustrated steps of detecting fused transcripts e by combining with FIG. 6.

1) Alignment of Re-Sequencing Data

a. aligning against a human genome reference, corresponding to a step of S601 in FIG. 6.

S601: paired-end RNA-Seq data was aligned to a human reference genome sequence. SOAP2.21 of alignment software was used for the alignment in this step (SOAP2.21 of alignment software was researched and developed by BGI SHENZHEN, of which a specific introduction may refer to Li R, Yu C, Li Y, Lam T W, Yiu S M, Kristiansen K, Wang J: SOAP2: an improved ultrafast tool for short read alignment. Bioinformatics 2009, 25:1966-1967).

3 types of results were obtained after the alignment: first paired-end mapped reads, first single-end mapped reads, and first unmapped reads. The first paired-end mapped reads indicated reads having a relationship of paired-end reads, of which two reads were mapped to the human genome reference, and a distance between such two reads satisfied a preset range of an insertsize (since relative long introns presented between two exons in the human genome reference, such present range was 0 to 10k); the first single-end mapped reads indicated read only having one mapped read, or paired-end mapped reads having an insertsize unsatisfied the present range; the unmapped reads indicated reads being not able to be mapped to the human genome reference.

The first paired-end reads were normal mapped paired-end read, which were not used in subsequence analyzing steps. Data for the subsequent analyzing steps were the first single-end mapped reads and the first unmapped reads. In step 601, the intersize evaluating an insertsize between two ends of the paired-end reads by means of the first paired-end mapped reads, to obtain a proportion of paired-end mapped reads with overlapped 3′-ends was evaluated by means of the first paired-end mapped reads, in which the paired-end mapped reads satisfied a condition that such two reads were mapped to a same exon. If 10 w quantitative paired-end mapped reads satisfied the above condition after counting, then the insertsize of the paired-end mapped reads was evaluated to provide effective information for the subsequent analyzing steps.

b. alignment against annotate transcripts, corresponding to a step of S602 in FIG. 6.

S602: the first unmapped reads were further aligned to annotated transcripts. SOAP software (http://soap.genomics.org.cn/soapaligner.html) developed by BGI SHENZHEN was used in the present step; besides bwa software (http://bio-bwa.sourceforge.net/) was used for aligning the second unmapped reads caused by indel, to further simplify the unmapped reads. Two types of results were obtained by S602: second single-end mapped reads and third unmapped reads, in which such reads exceeding exon boundary, which were not able to be integrally mapped to any single exon. The third unmapped reads indicated reads being not able to be mapped to the annotate transcript once more. By realignment using bwa, the unmapped reads caused by indel were filtered out, then a proportion of those unmapped reads caused by a fused gene in the third unmapped reads retained greatly elevated.

c. Trimming operation accessible to paired-end reads with overlapped 3′-ends, corresponding to steps of S603 and S604 in FIG. 6.

The proportion of paired-end mapped reads with overlapped 3′-ends was obtained by evaluating the intersize (S601). If the proportion of paired-end mapped reads with overlapped 3′-ends exceeds a threshold (preferably 5% to 50%, more preferably is 10% to 30%, most preferably is 20%), then the second unmapped reads were subjected to a trimming operation. Firstly, in step of S603 the second unmapped reads, obtained from being aligned against the annotate transcript, were subjected to a trimming operation to obtain a trimmed third unmapped reads; the paired-end reads with overlapped 3′-ends were converted into paired-end reads with a gap between two 3′-ends; then the trimmed third unmapped reads were realigned to the annotate transcript (S604), to obtain third single-end mapped reads.

d. merging all single-end mapped reads, corresponding to a step of S605 in FIG. 6. After previous steps of alignment, a serious result of single-end mapped reads was obtained. By merging these single-end mapped reads, aligned sites were converted into whole genome sites, so as to take values based on same rules in the subsequent analyzing steps.

2) Obtaining a Primary Set of Candidate Gene Pairs, Corresponding to a Step of S606 in FIG. 6.

a gene pair linked by a cross-read was found based on the merged result of all single-end mapped reads and combining with a relationship of the paired-end mapped reads, to obtain a primary set of candidate gene pairs, from which the subsequent steps would obtain a final determined fusion status. In such step, the gene pair was subjected to following filtrations:

a. filtering out gene pairs from the same families

As members in one gene family had similar functions and similar sequences with each other, those gene pairs belonged to the same families are filtered out. A list of gene families was downloaded from http://www.genenames.org/genefamily.html, for filtering out gene pairs from the same families.

b. filtering out gene pairs that overlapped each other

A homogenous exon region presented in some juxtaposition genes of genome, which would be regarded as a fused sequence, thus such gene pairs having homogenous exon region needed to be filtered.

c. filtering towards a cross-read orientation

In one read of the paired-end mapped reads having a synthesis orientation from 5′-end to 3′-end, read/1 and read/2 were obtained by paired-end sequencing (both extending from respective 5′-end of insert fragment towards interior of the insert segment). According to these characteristics of the paired-end sequencing, the fused gene pairs would be subjected to a certain filtration according to the cross-read orientation and alignment result, to retain fused paired reads having a fusing orientation supported by most cross-read.

d. filtering out alternative splicing

Each of the cross-read was aligned to a gene sequence to which the other read having a pairwise relationship thereof was able to be mapped by blast alignment software. For example, read/1 was aligned to gene A, read/2 was aligned to gene B, read/1 was aligned to a gene junction sequence of gene B and a whole genome sequence, to determine whether or not read/1 derived from alternative splicing of gene B; similarly, read/2 was also subjected to a same process.

Filtrations a. and b. were accessible directly in gene pairs, to determine whether or not such gene pairs could be retained; Filtrations c. and d. were accessible to cross-read, which altered the number of cross-read supporting gene pairs.

3) Determination of Fused Status

a. aligning useful unmapped reads to a junction library, corresponding to a step of S607 in FIG. 6.

The third unmapped reads obtained by aligning against annotate transcript in the above steps may be regarded containing most unmapped reads caused by fused gene. The third unmapped reads were bisected to obtain two half-unmapped reads, then the half-unmapped reads were aligned to a gene-junction sequence. Assuming that a certain unmapped read resulted from a fused gene, which means that the certain unmapped read contained a fused gene in the middle, then maximal one half-unmapped read derived thereof contained the fused gene, and the other one half-unmapped read was certainly be able to be mapped to a gene from which the unmapped read derived. Accordingly, a potent region containing a fused junction site of such gene may be calculated based on such alignment of half-unmapped reads (i.e. within a length range of one unmapped read at both left and right of the aligned site respectively); original reads of mapped half-unmapped reads were output, which were called as useful unmapped reads.

b. constructing junction sequences library with partial exhaustion algorithm; and based on alignment result, obtaining candidate fusions supported (mapped) by useful unmapped reads (candidate junc-reads) corresponding to a step of S608 in FIG. 6.

For those fused gene pairs in the candidate set candidate set, a range of the potent region containing a fused junction site was obtained by bisecting the third unmapped read, then bases on an alignment position of each fused gene supported by cross-read and the calculated intersize in above steps, all possible simulations would be subjected to partial exhaustion algorithm, to obtain every possible fused sequence. Then the useful unmapped reads were aligned to a simulated fused sequence, those simulated fused sequences supported by useful unmapped reads would be found based on the alignment result, then a corresponding fused status would be determined. A general partial exhaustion algorithm model was shown in FIG. 8.

4). Final Result Gathering

a. calculating cross-read and span-read, corresponding to a step of S609 in FIG. 6.

Those reads with determined fusion status were subjected to calculation based on the useful unmapped reads mapped to a simulated sequence by partial exhaustion algorithm and cross-read in the candidate gene pair.

b. The determined fused gene pairs were subjected to a further filtration, corresponding to a step of S610 in FIG. 6.

<1> simplified fusion within one same gene pair, preferably, a gene fusion presenting in a boundary of exons is retained; and

<2> filtering out a fused site between homogenous genes, to remove a fused sequence containing a fused site located in a homogenous region between genes.

### Example 2

### Evaluation of Performance

To assess the performance of the present disclosure, two groups of RNA-Seq data were used for analysis. These two groups of RNA-Seq data were also analyzed by commonly-used software, such as chimerascan, deFuse, FutionHunter, Hat-Fusion.

These two groups of RNA-Seq data were respectively obtained based on two published paper below:

1) Berger M F, Levin J Z, Vijayendran K, Sivachenko A, Adiconis X, Maguire J, Johnson L A, Robinson J, Verhaak R G, Sougnez C, et al. 2010. Integrative analysis of the melanoma transcriptome. Genome Res 20: 413-427. The cancer involved in this paper was melanoma, with 7 samples in which 15 of PCR products had been determined as being fused.

2) Edgren H, Murumaegi A, Kangaspeska S, Nicorici D, Hongisto V, Kleivi K, Rye I H, Nyberg S, Wolf M, Boerresen-Dale A L, et al. Identification of fusion genes in breast cancer by paired-end RNA-sequencing. Genome Bio 1.12:R60. The cancer involved in this paper was breast cancer, with 4 samples, in which 27 of PCR products had been determined as being fused.

Table 1 showed a result of performance and efficiency of each verification

TABLE 1

| | software | | | | |
|---|---|---|---|---|---|
| Item | SOAPfuse | chimerascan | deFuse | FusionHunter | TopHat-Fusion |
| mean_cpu time* | 6.1 h, 4.7 h | 104.78 h, 44.24 h | 61.06 h, 23.63 h | 23.33 h, 19.89 h | 18.33 h, 8.29 h |
| [symbol] | 7.04G, 6.32G | 4.34G, 4.37G | 14.79G, 13.95G | 9.65G, 11.26G | 17.09G, 17.02G |
| [symbol] | 15/15, 25/27 | 4/15, 20/27 | 12/15, 20/27 | 12/15, 15/27 | 4/15, 20/27 |

Note:
comma presented in each unit frame as a separator, melanoma data was shown prior to the separator, breast cancer data was shown after the separator.
All * mean_cpu time were obtained by an order of Linux system; considered a multi-thread case, all data shown in Table 1 were a calculating time by single thread.
** data format: the detected number of fused gene/the verified number of fused gene [symbol]
indicates data missing or illegible when filed

By comparing here obtained:

a) the mean_cpu-time by the method of the present disclosure was the shortest, running fastest, other software all required a cup-time over 8 hours, thus the method of the present disclosure run fast which would save time and cost;

b) the maximal memory used in the method of the present disclosure was 7G, which was the least among other methods. The used memory respectively used in other software was over 9G, in which the more memory being used, the higher requirements for the software running hard disk system. In particular, when analyzing hundreds of samples in parallel, insufficient memory led to delayed analysis. In addition, a high requirement of memory increased research cost;

c) the method of the present disclosure had the most excellent detection efficiency. There were 15 fused genes in melanoma which had been verified to be fused, in which all of these 15 fused genes were found by the method of the present disclosure, other software would only find 12 melanoma maximum. There are 27 fused genes in breast cancer which had been verified to be fused, in which 25 fuses genes were found by the method of the present disclosure superior to other software. Thus, high detecting efficiency was the greatest advantage of the present disclosure, which was the most important for scientific research;

d). besides, a directory based on the software used in the present disclosure was simple and clear, a file of each steps had a respective directory, which was stored in a certain structure of directory for greatly easy searching; and a compressible file was stored by compressing in gzip (an compressing order of Linux system) format, which would reduce storage space of hard disk, so as to further reduce cost;

e). operations for running the method of the present disclosure were simple. Only list file, config file, and RNA-Seq data to be analyzed (with format of fastq or fasta) were required to be provided by a user. The list file stored information of samples to be analyzed, the config file had examples of which parameter would be modified or set by the user as required;

f) basic database required for the present disclosure would be downloaded from website (http://soap.genomics.org/cn/soapfuse.html), or would be self-constructed according to current requirements, of which constructing steps were simple and quick, accordingly the user would construct an own database.

### Example

### Verification

1. biology sample

One sample of breast cancer, KPL-4.

2. Paired-end RNA-Seq data of KPL-4 sample derived from database:

SRR064287.sra under a directory of:
ftp://ftp-trace.ncbi.nlm.nih.gov/sra/sra-instant/reads/Bysample/sra/SRS107/SRS107531/SRR064287.

Basic database: using hg19, ensemble release59 annotations, which could be downloaded from a linkage of:

ftp://public.genomics.org.cn/BGI/soap/hg19-GRCh37.59.for.SOAPfuse.tar.gz.

3. software

Software for detecting fused transcripts, of which a software package would be downloaded from:

ftp://public.genomics.org.cn/BGI/soapfuse-v1.1.tar.gz

config files used for processing the KPL-4 data would be downloaded from:

ftp://public.genomics.org.cn/BGI/soap/real_data.tar.gz

config was breast_cancer.data.config.txt containing in a config file of the compressed package.

SRA conversion tool, sratoolkit, of which a software package would be downloaded from:

http://trace.ncbi.nlm.gov/Trace/sra/sra.cgi?cmd=show&f=software&m=software&s=software/sratoolkit2.1.7-centos_linux64.tar.gz

4. Hard Disk Requirement for the Software of the Present Disclosure

(1) 64 x86-64-based servers managed by SSE framework;

(2) not less than 7G of random access memory (RAM);

(3) not less than 50G of storage space of hard disk.

5. Software Requirement for the Software of the Present Disclosure

(1) 64-bit Linux operating system

(2) gcc complier with a version at least 4.2.4;

(3) perl with a version at least 5.8.5.

6. Procedures Running by the Software

6.1 Sratoolkit Installation, Official Links:

http://www.ncbi.nlm.nih.gov/books.NBK47540/#SRA; Guild B.3 Installing was also downloaded.

6.2 SRA Files Downloaded from NCBI were Converted to Fastq Files Using Sratoolkit.

/DIR_sratoolkit_installed/ was taken as an installation directory;

/DIR_SRA_stored/ was taken as a storage directory.

$ cd /DIR_SRA_stored/
$ /DIR_sratoolkit_installed/fastq-dump -A SRR064287 /DIR_SRA_stored/
SRR064281.sra
$ for i in [symbol] Is /DIR_SRA_stored/*.fastq [symbol] ;do gzip -cd $i > $i.gz &&
rm $i;done

Two files of SRR064287_{—}1.fastq.gz [symbol] SRR064287_{—}2.fasq.gz presented in the directory of /DIR_SRA_stored/.

6.3 Releasing the Compressing Package of soapfuse-v1.1.tar.gz

/DIR_TARBALL_IS_PUT/ was taken as a storage directory for the compressing package.

$ tar -xzf / DIR_TARBALL_IS_PUT/soapfuse-v1.1.tar.gz
$ cd soapfuse-v1.1/
$ perl soapfuse-RUN.pl

6.4 Adding the Downloaded Database to a Directory after Extracting the Compressing Package

/DIR_DATA_BASE_IS_PUT/ was taken as a directory storing the downloaded compressing package.

/DIR_SOAPfuse_IS_RELEASED/ was the directory where the released SOAPfuse compressing package located.

$ cd /DIR_SOAPfuse_IS_RELEASED/SOAPfuse-V1.1/source/database
$ tar -xzf /DIR_DATABASE_IS_PUT/hg19-GRCh37.59.tar.gz

6.5 Creating a File of sample.list with Formats:

| 1 | 2 | 3 | 4 |
|---|---|---|---|
| Sample ID | Seq-library name | Seq-line name | read length |
| sample_ID | lib_name | lane_name | read_length |

Each line contained information of one lane, if the number of lane data was K, it needed to be written in K lines.

The sample.list file of the present example was written as:

6.6 Setting the Downloaded Config File

The downloaded text file of breast_cancer.data.config.txt was subjected to compiling, following contents needed to be set as:

Directory of basic database

DB_db_dir=/DIR_SOAPfuse_IS_RELEASED/SOAPfuse-V1.1/Source/database/hg19-GRCh37.59

program directory

PG_pg_dir=/DIR_SOAPfuse_IS_RELEASED/SOAPfuse-V1.1/source/bin

process script directory:

PS_ps_dir=/DIR_SOAPfuse_IS_RELEASED/SOAPfuse-V1.1/source

6.7 Constructing a Directory Structure of Original Sequencing Database

/DIR_SEQ_DATA_IS_PUT/ was taken as a directory storing sequencing data.

Based on content in the sample.list file, the sequencing data were stored under following directory structure.

/DIR_SEQ_DATA_IS__PUT/sample_ID/lib_name/lane_name_[12].fastq.gz
[KPL-4 [symbol] [symbol]
/DIR_SEQ_DATA_IS_PUT/KPL-4/SRX025832/SRR064287_1.fastq.gz
/DIR_SEQ_DATA_IS_PUT/KPL-4/SRX025832/SRR064287_2.fastq.gz

6.8 Running Software to Obtain Results

/DIR_CONFIG_IS_PUT/ was taken as a directory where breast_cancer.data.config.txt located.

/DIR_LIST_IS_PUT/ was taken as a directory where the sample.list located.

/DIR_ALL_OUTPUT/ was taken as a directory of total outputting result.

$ perl /DIR_SOAPfuse_IS_RELEASED/SOAPfuse-V1.1/soapfuse-RUN.pl \
-c /DIR_CONFIG_IS_PUT/breast_cancer.data .config.txt \
-fd /DIR_SEQ_DATA_IS_PUT/ \
-l /DIR_LIST_IS_PUT/sample.list \
-o /DIR_ALL_OUTPUT/ \
-tp KPL-4 -fm

Note: a. parameter of -tp and -tm were both optional parameter, it was recommended to set as the above description, to accelerate program running and facilitate searching.

b. It required about 4 hours of cup-time to processing data of KPL-4. Actual time also related to used cpu frequency and IO status, within 3 hours for completing process.

6.9 Examining Results

$ less -S
/DIR_ALL_OUTPUT/final_fusion_genes/KPL-4/KPL-4.homo-
F.simplified.span-A.finalFusion

With format shown as below:

| columns | explanations |
|---|---|
| 1 (6) | upstream (downstream) gene name |
| 2 (7) | chromosome in which the upstream (downstream) gene located |
| 3 (8) | strand in which the upstream (downstream) gene located |
| 4 (9) | a junction site of a gene-junction sequence where the unstream |
| | gene located |
| 5 (10) | a junction site of a genome chromosome where the unstream |
| | gene located |
| 11 | the number of cross-read |
| 12 | the number of span-read |
| 13 | a juction site of upstream gene |
| 14 | a juction site of downstream gene |

fused gene:

/DIR_ALL_OUTPUT/final_fusion_genes/KPL-4/analysis/fusion.seq

figure of fused gene:

/DIR_ALL_OUTPUT/final_fusion_genes/KPL-4/analysis/figures/fusion/*.svg

figure of gene depth:

/DIR_ALL_OUTPUT/final_fusion_genes/KPL-4/analysis/figures/expression/figures/*.svg

3 fused gene were found in KPL-4 sample by PCR verification, within the results of KPL-4.homo-F-simplified.span-A.finalfusion.

| | upstream | upstream | | downstream | downstream |
|---|---|---|---|---|---|
| upstream gene | chromosome | junction site | downstream gene | chromosome | junction site |
| BSG | chr19 | 580782 | NFIX | chr19 | 13135835 |
| NOTCH1 | chr9 | 139438476 | NUP214 | chr9 | 134062676 |
| PPP1R12A | chr12 | 80211174 | SEPT10 | chr2 | 110343415 |

In addition, fused genes which had never been reported were also found in data of the KPL-4 sample, which were shown as below:

| | upstream | upstream | | downstream | downstream |
|---|---|---|---|---|---|
| upstream gene | chromosome | junction site | downstream gene | chromosome | junction site |
| AC107956.2 | chr11 | 17229396 | PIK3C2A | chr11 | 17191354 |
| EEF1DP3 | chr13 | 32520318 | FRY | chr13 | 32652971 |
| EHMT1 | chr9 | 140913501 | NTNG2 | chr9 | 135073353 |
| SCNN1A | chr12 | 6457893 | TNFRSF1A | chr12 | 6443410 |

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

1. A method of detecting fusion transcripts in a sample to be analyzed, comprising following steps:
subjecting the sample to be analyzed containing a RNA transcriptome to paired-end sequencing, to obtain paired-end RNA-Seq data of the sample to be analyzed;
aligning the paired-end RNA-Seq data to a human reference genome sequence, to obtain first paired-end mapped reads, first single-end mapped reads, and first unmapped reads;
evaluating an insertsize between two ends of the paired-end mapped reads using the first paired-end mapped reads, to obtain a proportion of paired-end mapped reads with overlapped 3′-ends;
aligning the first unmapped reads to annotated transcripts, to obtain second single-end mapped reads and second unmapped reads;
aligning the second unmapped reads to the annotated transcripts, to filter out unmapped reads caused by indel and obtain third unmapped reads;
merging all single-end mapped reads, to obtain a set of single-end mapped reads;
obtaining a gene pair linked by a cross-read as a primary set of candidate gene pairs based on the set of single-end mapped reads and combining with a relationship of the mapped paired-end reads;
subjecting the primary set of candidate gene pairs to a filtration, to obtain a candidate set of fused gene pairs;
bisecting the third unmapped read, to obtain a half-unmapped read;
aligning the half-unmapped read to a gene-junction sequence in the candidate set of fused gene pairs, to obtain a potent region of a fused junction site in the gene in which the half-unmap read locates;
outputting original reads of mapped half-unmapped reads, to obtain useful unmapped reads;
subjecting the candidate set of fused gene pairs to a fusion simulation;
aligning the useful unmapped reads to a junction library, to obtain a fused gene supported by the useful unmapped reads;
calculating and gathering the fused sequence supported by the useful unmapped reads, to obtain information of the fused gene,
wherein the information of the fused gene is at least one selected from a group consisting of:
fused gene site, gene ID, plus or minus strand of gene, chromosome in which gene locates, a position of fused site in gene, or a combination thereof.

2. The method of claim 1, wherein the first paired-end mapped reads indicates reads having a relationship of paired-end mapped reads, and the intersize between two ends of the paired-end reads satisfies Formula I:
0<insert size<10K Formula I.

3. The method of claim 1, wherein the first single-end mapped reads is at least one selected from a group consisting of:
a) single read being able to be mapped to the human reference genome sequence; and/or
b) reads having the relationship of paired-end reads and being able to be mapped to the human reference genome sequence, and the intersize between two ends of the paired-end reads doses not satisfy Formula I.

4. The method of claim 1, wherein the first unmapped reads are: reads being unable to be mapped to the human reference genome sequence.

5. The method of claim 1, wherein if the proportion of paired-end mapped reads with overlapped 3′-ends exceeds a threshold, the method further comprises:
subjecting the second unmapped reads to a trimming operation, to obtain a trimmed third unmapped reads by which the paired-end reads with overlapped 3′-ends is converted into paired-end reads with a gap between two 3′-ends; and
aligning the trimmed third unmapped reads to the annotated transcript, to obtain third single-end mapped reads.

6. The method of claim 5, wherein the threshold i preferably is 5% to 50.

7. The method of claim 1, wherein the first filtration is at least one selected from a group consisting of:
(A) filtering out juxtaposition genes having a homogenous exon region;
(B) filtering towards a cross-read orientation, to retain fused paired reads having a fusing orientation supported by most cross-read; and
(C) filtering out alternative splicing;
wherein the filtration further comprises: filtering out gene pairs from the same gene families.

8. The method of claim 1, wherein the step of calculating comprises:
subjecting reads with determined fusion status to the calculation, based on the useful unmapped reads mapped to a simulated sequence by partial exhaustion algorithm and cross-read in the candidate gene pair.

9. The method of claim 1, wherein the step of gathering comprises:
filtering a candidate fusion with criterions, wherein the criterions are:
simplified fusion within one same gene pair, wherein a gene fusion presenting in a boundary of exons is retained; and
filtering out a fused site between homogenous genes, to remove a fused sequence containing a fused site located in a homogenous region between genes.

10. The method of claim 1, further comprising steps of:
drawing an svg figure showing fusion status based on the calculated and gathered result;
drawing a graph showing expression level of gene pairs; and
creating the fused gene.

11. The method of claim 1, wherein the method is used in:
verifying gene fusion in a RNA level; or
determining whether or not the fusion results from DNA structure variation; or
providing absolute expression levels of two genes involved in the fusion; or
a combination thereof.

12. A system for detecting a fused gene in a sample to be tested, comprising:
an aligning unit, configured to align sequencing data to a reference sequence;
a filtering unit, configured to filter or exclude sequencing data with a low confidence and being wrong;
a fusion simulating unit, configured to subject a candidate set of fused gene pairs to a fusion simulation, to obtain a fused gene;
a reads cutting unit, configured to bisect third unmapped reads, to obtain half-unmap/1 and half-unmap/2.

13. The system of claim 12, wherein the system further comprises at least one unit selected from a group consisting of:
a receiving unit, configured to receive paired-end RNA-Seq data of the sample to be analyzed;
a fused gene predicting unit, configured to predict the fused gene based on the half-unmap/1 and half-unmap/2;
a figure drawing unit.

14. The method of claim 12, wherein the aligning unit comprises at least one module selected from a group consisting of:
a first aligning module, configured to align paired-end RNA-Seq data to a human reference genome sequence;
a second aligning module, configured to align first unmapped reads to annotated transcripts;
a third aligning module, configured to align second unmapped reads to the annotated transcripts;
a fourth aligning module, configured to align half-unmap reads deriving from third unmapped reads to a gene-junction sequence in a candidate set of fused gene pairs.

15. The method of claim 12, wherein the filtering unit comprises at least one module selected from a group consisting of:
a first filtering module, configured to filter a gene pair linked by a cross-read as a primary set of candidate gene pairs; and/or
a second filtering module, configured to filter a fused gene supported by useful unmapped reads;
preferably, the first filtering module is used in
(A) filtering out juxtaposition genes having a homogenous exon region;
(B) filtering towards a cross-read orientation, to retain fused paired reads having a fusing orientation supported by most cross-read; and
(C) filtering out alternative splicing;
wherein the first filtering module for the primary set of candidate gene pairs is further used in filtering out gene pairs from the same gene families;
wherein the second filtering module for filtering the fused gene supported by the useful unmapped reads satisfies following criterions:
simplified fusion within one same gene pair, wherein a gene fusion presenting in a boundary of exons is retained; and
filtering out a fused site between homogenous genes, to remove a fused sequence containing a fused site located in a homogenous region between genes.

16. The method of claim 12, wherein the reads cutting unit is used in:
bisecting the third unmapped reads, to obtain half-unmap/1 and half-unmap/2,
wherein the reads cutting unit bisects the third unmapped reads into two isometric segments, to obtain the half-unmap/1 and half-unmap/2 having same length.

17. The method of claim 13, wherein the figure drawing unit comprise:
a first drawing module, configured to draw alignments of supporting reads;
a second drawing module, configured to draw svg figures showing absolute expression level of two genes involved in the fusion.
